(19) United States
(12) Patent Application Publication
(10) Pub. No.: US 2019/0004505 A1
(43) Pub. Date: Jan. 3, 2019

(54) INTERLOCK CHAIN VISUALIZATION

(71) Applicant: FISHER-ROSEMOUNT SYSTEMS, INC., Round Rock, TX (US)

(72) Inventors: Prashant Joshi, Leicester (GB); Julian K. Naidoo, Cedar Park, TX (US); Daniel R. Strinden, Austin, TX (US); Cristopher Ian Sarmiento Uy, Metro Manila (PH)

(21) Appl. No.: 15/635,793

(22) Filed: Jun. 28, 2017

(51) Int. Cl. G05B 19/418; G06T 11/20

(52) U.S. Cl. CPC G05B 19/41885; G06T 11/206; G06F 3/0482; G06T 2200/24; G05B 2219/32351

(57) ABSTRACT

A method of visualizing one or more interlock chains in a process control system includes detecting an interlock event, obtaining pre-configured interlock logic data associated with field components in the process control system, and automatically generating at least a first interlock chain visualization by analyzing the pre-configured interlock logic data. The visualization graphically indicates interlock dependencies among at least a subset of the field components. The method also includes causing the first interlock chain visualization, and possibly other, related chain visualizations, to be presented to a user via a user interface, alone or with related controls (e.g., for resetting all components in the visualized chain).

### TECHNICAL FIELD

The present disclosure relates generally to process control systems and, more particularly, to methods and systems for enabling users to visualize interlocked field component chains within process control systems.

### BACKGROUND

Distributed process control systems, like those used in chemical, petroleum, industrial or other process plants to manufacture, refine, transform, generate, or produce physical materials or products, typically include one or more process controllers communicatively coupled to one or more field devices via analog, digital, or combined analog/digital buses, or via a wireless communication link or network. The field devices, which may be, for example, valves, valve positioners, switches, transmitters, sensors, etc., are located within the process control environment and generally perform physical or process control functions such as opening or closing valves, measuring process and/or environmental parameters (e.g., temperature or pressure), etc., to control one or more processes executing within the process plant or system. Smart field devices, such as field devices conforming to the well-known Fieldbus protocol, may also perform control calculations, alarming functions, and/or other control functions commonly implemented within the controller. The process controllers, which are also typically located within the plant environment, receive signals indicative of process measurements made by the field devices, and/or other information pertaining to the field devices, and execute a controller application that runs, for example, different control modules. The control modules make process control decisions, generate control signals based on the received information, and coordinate with the control modules or blocks being performed in the field devices, such as HART®, WirelessHART®, or FOUNDATION® Fieldbus field devices. The control modules implemented in the controller send the control signals over communication lines or links to the field devices to thereby control the operation of at least a portion of the process plant or system, e.g., to control at least a portion of one or more industrial processes running or executing within the plant or system. I/O devices, which are also typically located within the plant environment, typically are disposed between a controller and one or more field devices to enable communications, e.g., by converting electrical signals into digital values and vice versa.

Information from the field devices and the controller is usually made available over a communication network to one or more other hardware devices, such as operator workstations, personal computers or computing devices, data historians, report generators, centralized databases, or other centralized administrative computing devices that are typically placed in control rooms or other locations away from the harsher field environment of the plant. These hardware devices run applications that may, for example, enable an operator to perform functions with respect to controlling a process and/or operating and monitoring the process plant (e.g., changing settings of the process control routine, modifying the operation of the control modules within the controllers or the field devices, viewing the current state of the process, viewing alarms generated by field devices and controllers, simulating the operation of the process for the purpose of training personnel or testing the process control software, keeping and updating a configuration database, etc.). The communication network utilized by the hardware devices, controllers, and field devices may include a wired communication path, a wireless communication path, or a combination of wired and wireless communication paths.

As an example, the DeltaV™ control system, sold by Emerson Process Management, includes multiple applications stored within and executed by different devices located at diverse places within a process plant. A configuration application, which resides in one or more workstations or computing devices in a back-end environment of a process control system or plant, enables users to create or change process control modules and download these process control modules via a communication network to dedicated distributed controllers. Typically, these control modules are made up of communicatively interconnected function blocks, which are objects in an object oriented programming protocol that perform functions within the control scheme based on inputs thereto and that provide outputs to other function blocks within the control scheme. The configuration application may also allow a configuration designer to create or change operator interfaces which are used by a viewing application to display data to an operator and to enable the operator to change settings, such as set points, within the process control routines. Each dedicated controller and, in some cases, one or more field devices, stores and executes a respective controller application that runs the control modules assigned and downloaded thereto in order to implement actual process control functionality. The viewing applications, which may be executed on one or more operator workstations (or on one or more remote computing devices in communicative connection with the operator workstations and the communication network), receive data from the controller application via the communication network and display this data to process control system designers, operators, or other users using the user interfaces, and may provide any of a number of different views, such as an operator's view, an engineer's view, a technician's view, etc. A data historian application typically stores the current process control routine configuration and data associated therewith.

Generally, a process plant or system includes field devices, equipment, and other components that operate in a highly interdependent manner. Thus, faulty operation of one component may require stoppage of one or more other components in order to avoid a dangerous or otherwise undesired situation. As a simple example, if an upstream conveyor feeds materials to another, downstream conveyor, a breakdown of the downstream conveyor may require stopping the upstream conveyor in order to avoid an overflow of the materials at the downstream conveyor. While not required, it may also be desirable to stop the downstream conveyor if the upstream conveyor stops working. To automate such stoppages, a system designer may configure specific control blocks, field devices, etc., according to suitable “interlock” logic. For example, a control module may be configured to automatically stop a motor of the upstream conveyor when the downstream conveyor experiences a stoppage or other fault. Any other conveyor motors or other components that are further upstream (and, optionally, any other conveyor motors or other components that are further downstream) may also be stopped automatically.

In other scenarios, it may be necessary or desirable to automatically stop other components, including those that are not physically upstream or downstream of a component that fails. Thus, an interlock relationship may be more generally described in terms of a “parent” and “child,” where the child is automatically stopped if the parent fails (e.g., breaks down, or fails to operate within predetermined fault tolerances, etc.). A series of multiple parent/child pairs is referred to herein as an “interlock chain.” For example, failure of an output valve may cause automatic stoppage of a first pump that is physically upstream of the valve, which may in turn cause automatic stoppage of a second pump that is physically upstream of the first pump, and so on. Moreover, multiple interlock chains may share one or more common components, in which case components in two or more intersecting chains may be interlocked if a component in one of the chains fails.

Typically, “display views” for field devices may be configured to indicate adjacent upstream and/or downstream devices. To discover the primary source/cause of an interlock, the operator must use this information to hunt up and/or down the device path (e.g., by navigating between the display views of different devices). In practice, however, interlock chains can include many field devices and/or other components, and/or individual chains may intersect with a significant number of other chains. Thus, it may be quite difficult for a human operator to determine which field device or other component ultimately caused stoppage of the components in an interlock chain. Moreover, after the cause of the interlock is discovered and resolved, the operator must again navigate back along the various display views for all of the field devices in the interlock chain in order to reset each device. These actions can lead to a significant amount of extra “downtime,” which in many cases can be very costly. Furthermore, in current systems, the indications of upstream and downstream devices in a display view for a given field device (i.e., the indications used by the operator to navigate between devices) are manually configured. Thus, if an interlock chain changes due to a system reconfiguration, the display views must be manually reconfigured as well.

### SUMMARY

Techniques, systems, apparatuses, and methods for providing interlock chain visualizations are disclosed herein. Said techniques, systems, apparatuses, and methods may apply to industrial process control systems, environments, and/or plants, which are interchangeably referred to herein as “industrial control,” “process control,” or “process” systems, environments, and/or plants. Typically, such systems and plants provide control, in a distributed manner, of one or more processes (also referred to herein as “industrial processes”) that operate to manufacture, refine, or otherwise transform raw physical materials to generate or produce products.

An interlock chain, or set of related interlock chains, may be visualized by means of a diagram that includes some or all field components in the interlock chain(s) and illustrates their respective interconnections and dependencies. As utilized herein a “field component” (or simply “component”) may refer to a field device, a piece of equipment, a portion of a field device or piece of equipment, or a system or subsystem that includes multiple field devices and/or pieces of equipment. Each field components is typically located, disposed, or installed in a field environment of a process control system or plant and, if an object oriented programming protocol is used, each field component may correspond to a respective instance of a component object. The diagram or visualization may be shown on, or launched from, a graphical user interface (GUI) that is presented when a particular interlocked component has been selected or is otherwise being viewed (e.g., when a human operator is viewing information associated with an interlocked component), and may allow an operator to more quickly identify the source of an interlock, and/or more quickly identify the set of components affected by the interlock. Moreover, the diagram may include a virtual, interactive control that enables the user to reset all components in the visualized interlock chain with only a single input (or multiple inputs, e.g., if the operator must confirm the selected reset command), and or a control that enables the user to bypass the interlock for the visualized chain.

To avoid (or reduce) the need to manually configure the display of an interlock chain diagram, the diagram may be automatically generated by analyzing/interpreting the current state of pre-configured interlock logic. In some embodiments, the individual interlocking or chaining between different components is pre-configured using an interlock configuration object that is available out-of-box to system designers within a control module. A system designer may generate the interlock logic by creating instances of the interlock configuration object when configuring the process control system, and the interlock chain diagram may be automatically generated by analyzing the resulting interlock configuration object instances. Accordingly, if the interlock logic is reconfigured (e.g., by modifying, creating, and/or deleting instances of the interlock configuration object), the interlock chain diagram may automatically provide a current, updated representation of interlock chains based on the present configuration of interlocks. In contrast, conventional component displays are manually configured to depict specific interlocks, such that all of the affected displays must be manually reconfigured if the interlock logic changes.

The interlock chain diagram may depict an entire interlock chain, or a subset of the chain. For example, the diagram may only depict the portion of the chain between a presently-selected component and the source of the interlock/stoppage (i.e., the component ultimately responsible for stopping the selected component). Moreover, the diagram may depict one or more additional interlock chains. For example, the diagram may depict not only the chain (or chain portion) that includes the selected component, but also another chain (or chain portion) that shares a common “parent” component with the chain that includes the selected component. If multiple interlock chains are depicted, an interactive reset control may be presented for each chain.

### BRIEF DESCRIPTION OF THE DRAWINGS

FIG. 1 is a block diagram of an example process control system in which one or more of the interlock chain visualization techniques described herein may be implemented.

FIG. 2 depicts an example interlock configuration object that may be used when configuring portions of the process control system of FIG. 1.

FIG. 3 depicts an example physical configuration of components in the process control system of FIG. 1.

FIG. 4 depicts an example interlock chain diagram that may be automatically generated after an interlock occurs in the physical configuration of FIG. 3, according to one example scenario.

FIG. 5 depicts another example physical configuration of components in the process control system of FIG. 1.

FIGS. 6A-6C depict alternative, example interlock chain diagrams that may be automatically generated after an interlock occurs in the physical configuration of FIG. 5.

FIG. 7 is a flow diagram of an example method for visualizing one or more interlock chains in a process control system.

### DETAILED DESCRIPTION

### Example Process Control Environment

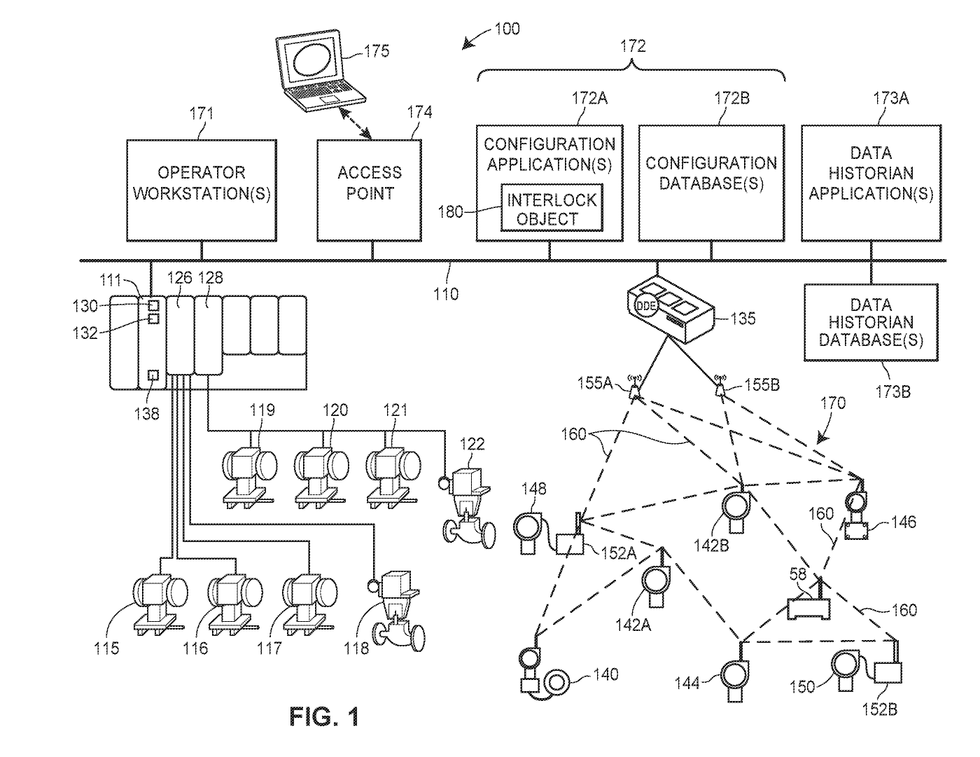

FIG. 1 is a block diagram of an example process control environment 100 in which one or more of the interlock chain visualization techniques described herein may be implemented. The process control environment 100 (which is also interchangeably referred to herein as a process control system 100 or process plant 100) includes one or more process controllers that receive signals indicative of process measurements made by field devices, process this information to implement a control routine, and generate control signals that are sent over wired and/or wireless process control communication links or networks to other field devices to control the operation of a process in the plant 100. Typically, at least one field device performs a physical function (e.g., opening or closing a valve, causing a conveyor to move materials, increasing or decreasing a temperature, taking a measurement, sensing a condition, etc.) to control the operation of a process. Some types of field devices communicate with controllers by using I/O devices. Process controllers, field devices, and I/O devices may be wired or wireless, and any number and combination of wired and wireless process controllers, field devices, and I/O devices may be included in the process plant environment or system 100.

For example, FIG. 1 illustrates a process controller 111 that is communicatively connected to wired field devices 115-122 via input/output (I/O) cards 126 and 128. The process controller 111 includes a processor 130, a memory 132, and one or more process control routines 138 that are discussed in further detail below. The controller 111 is also communicatively connected to wireless field devices 140-146 via a process control communication network or backbone 110 and a wireless gateway 135. The backbone 110 may include one or more wired and/or wireless communication links, and may be implemented using any suitable communication protocol such as, for example, an Ethernet protocol. In some configurations (not shown in FIG. 1), the controller 111 may be communicatively connected to the wireless gateway 135 using one or more communications networks other than the backbone 110, such as by using any number of other wired or wireless communication links that support one or more communication protocols, e.g., an IEEE 802.11-compliant wireless local area network protocol, a mobile communication protocol (e.g., WiMAX, LTE, etc.), Bluetooth®, HART®, WirelessHART®, Profibus, FOUNDATION® Fieldbus, etc.

The controller 111 (which, by way of example, may be the DeltaV™ controller sold by Emerson Process Management) may operate to implement a batch process or a continuous process using at least some of the field devices 115-122 and 140-146. In an embodiment, in addition to being communicatively connected to the backbone 110, the controller 111 is also communicatively connected to at least some of the field devices 115-122 and 140-146 using any desired hardware and software associated with, for example, standard 4-20 mA devices, I/O cards 126, 128, and/or any suitable smart communication protocol such as the FOUNDATION® Fieldbus protocol, the HART® protocol, the WirelessHART® protocol, etc. In FIG. 1, the controller 111, the field devices 115-122 and the I/O cards 126, 128 are wired devices, and the field devices 140-146 are wireless field devices. Of course, the wired field devices 115-122 and wireless field devices 140-146 could conform to any other desired standard(s) or protocols, such as any suitable wired or wireless protocols, and including any suitable standards or protocols developed in the future.

The processor 130 of process controller 111 implements or oversees the one or more process control routines or modules 138, which may be stored in the memory 132. To this end, the processor 130 is configured to communicate with the field devices 115-122 and 140-146, and with other nodes that are communicatively connected to the controller 111. It should be noted that any control routines or modules described herein may have parts thereof implemented or executed by different controllers or other devices if so desired. Likewise, the control modules 138 to be implemented within the process control system 100 may take any form, including software, firmware, hardware, etc. Control routines may be implemented in any desired software format, such as using object oriented programming, ladder logic, sequential function charts, function block diagrams, or using any other software programming language or design paradigm. The memory 132, on which some or all of the control modules 138 may be stored, may be any suitable type of memory or memories, such as random access memory (RAM) and/or read only memory (ROM). Moreover, the control modules 138 may be hard-coded into, for example, one or more EPROMs, EEPROMs, application specific integrated circuits (ASICs), or any other hardware or firmware elements. Thus, the controller 111 may be configured in any desired manner to implement a control strategy or control routine/module.

The controller 111 implements a control strategy using what are commonly referred to as function blocks, where each function block is an object or other part (e.g., a subroutine) of an overall control routine and operates in conjunction with other function blocks (via communications called links) to implement process control loops within the process control system 100. Control-based function blocks typically perform one of an input function, such as that associated with a transmitter, a sensor or other process parameter measurement device; a control function, such as that associated with a control routine that performs PID, fuzzy logic, etc. control; or an output function which controls the operation of some device, such as a valve or conveyor motor, to perform some physical function within the process control system 100. Of course, hybrid and other types of function blocks exist. Function blocks may be stored in and executed by the controller 111, which is typically the case when these function blocks are used for, or are associated with, standard 4-20 mA devices and certain types of smart field devices (e.g., HART® devices), or may be stored in and implemented by the field devices themselves, which can be the case with FOUNDATION® Fieldbus devices. The one or more control modules 138 in the controller 111 may implement one or more control loops which are performed by executing one or more of the function blocks.

The wired field devices 115-122 may be any type or types of devices, such as sensors, valves, conveyor motors, transmitters, positioners, etc., while the I/O cards 126 and 128 may be any types of I/O devices conforming to a suitable communication or controller protocol. For example, the field devices 115-118 may be standard 4-20 mA devices or HART® devices that communicate over analog lines (or combined analog and digital lines) to the I/O card 126, while the field devices 119-122 may be smart devices, such as FOUNDATION® Fieldbus field devices, that communicate over a digital bus to the I/O card 128 using a FOUNDATION® Fieldbus communications protocol. In some embodiments, though, at least some of the wired field devices 115-122, and/or at least one of the I/O cards 126, 128, additionally or alternatively communicate(s) with the controller 111 using the backbone 110 and a suitable control system protocol (e.g., Profibus, DeviceNet, Foundation Fieldbus, ControlNet, Modbus, HART, etc.).

In FIG. 1, the wireless field devices 140-146 communicate via a wireless process control communication network 170 using a wireless protocol, such as the WirelessHART® protocol. Such wireless field devices 140-146 may directly communicate with one or more other devices or nodes of the wireless network 170 that are also configured to communicate wirelessly. To communicate with other nodes that are not configured to communicate wirelessly, the wireless field devices 140-146 may utilize a wireless gateway 135 connected to the backbone 110 or another process control communications network. The wireless gateway 135 provides access, from the backbone 110, to various wireless devices 140-158 of the wireless communications network 170. In particular, the wireless gateway 135 provides communicative coupling between the wireless devices 140-158, the wired devices 115-128, and/or other nodes or devices of the process control plant 100.

Similar to the wired field devices 115-122, the wireless field devices 140-146 of the wireless network 170 perform physical control functions within the process plant 100, e.g., opening or closing valves, taking measurements of process parameters, etc. The wireless field devices 140-146, however, are configured to communicate using the wireless protocol of the network 170. As such, the wireless field devices 140-146, the wireless gateway 135, and other wireless nodes 152-158 of the wireless network 170 may be producers and consumers of wireless communication packets.

In some configurations of the process plant 100, the wireless network 170 includes non-wireless devices. For example, in FIG. 1, a field device 148 may be a legacy 4-20 mA device and a field device 150 may be a wired HART® device. To communicate within the network 170, the field devices 148 and 150 are connected to the wireless communications network 170 via a respective one of wireless adaptors 152A, 152B. The wireless adaptors 152A, 152B support a wireless protocol, such as WirelessHART, and may also support one or more other communication protocols such as Foundation® Fieldbus, PROFIBUS, DeviceNet, etc. Additionally, in some configurations, the wireless network 170 includes one or more network access points 155A, 155B, which may be separate physical devices in wired communication with the wireless gateway 135, or may be integrated within the wireless gateway 135. The wireless network 170 may also include one or more routers 158 to forward packets from between wireless devices within the wireless communications network 170. The wireless devices 140-146 and 152-158 may communicate with each other, and with the wireless gateway 135, over wireless links 160 of the wireless communications network 170, and/or via the backbone 110.

In FIG. 1, the process control system 100 includes one or more operator workstations 171 that are communicatively connected to the backbone 110. Via the operator workstation(s) 171, human operators may monitor run-time operations of the process plant 100, as well as take any diagnostic, corrective, maintenance, and/or other actions that may be required. At least some of the operator workstations 171 may be located at various, protected areas in or near the plant 100, e.g., in a back-end environment of the plant 100, and in some situations, at least some of the operator workstations 171 may be remotely located (but nonetheless in communicative connection with the plant 100). Operator workstation(s) 171 may be wired or wireless computing devices.

The example process control system 100 is further illustrated in FIG. 1 as including one or more configuration applications 172A and one or more configuration databases 172B, each of which is also communicatively connected to the backbone 110. Various instances of the configuration application(s) 172A may execute on one or more computing devices (not shown in FIG. 1) to enable users to create or change process control modules and download these modules via the backbone 110 to the process controller 111 and/or other process controllers, as well as enable users to create or change operator interfaces via which an operator is able to view data and change data settings within process control routines. The configuration database(s) 172B store(s) the configured modules and/or operator interfaces. Generally, the configuration application(s) 172A and configuration database(s) 172B may be centralized and have a unitary logical appearance to the process control system 100 (although multiple instances of a configuration application 172A may execute simultaneously within the process control system 100), and the configuration database(s) 172B may be stored in a single physical data storage device or across multiple data storage devices. The configuration application(s) 172A, the configuration database(s) 172B, and user interfaces thereto (not shown in FIG. 1) collectively form a configuration or development system 172 for creating/configuring control and/or display modules. Typically, but not necessarily, the user interfaces for the configuration system 172 are different than the operator workstations 171, with the user interfaces for the configuration system 172 instead being utilized by configuration and development engineers irrespective of whether the plant 100 is operating in real-time, and with the operator workstations 171 being utilized by operators during real-time (or “run-time”) operations of the process plant 100.

In some embodiments, the configuration application(s) 172A provide(s) various objects that system designers may use to configure the process control system 100 (e.g., control modules, field device display views to be viewed by operators, etc.) as discussed above. One such object type or class may be an interlock configuration object 180. Each instance of the interlock configuration object 180 may represent a parent/child interlock relationship between two specific components (e.g., two field devices, or a field device and another type of component, etc.), and may be stored in one of configuration database(s) 172B. Instances of the interlock configuration object 180 may be referenced by an instance of a particular control module object, for example. The instances of the interlock configuration object 180 may be used to automatically generate interlock chain visualizations, as discussed in further detail below.

The example process control system 100 also includes one or more data historian application(s) 173A and one or more data historian database(s) 173B, each of which is communicatively connected to the backbone 110. The data historian application(s) 173A operate(s) to collect some or all of the data provided across the backbone 110, and to store the data in the data historian database(s) 173B for long term storage. Similar to the configuration application(s) 172A and configuration database(s) 172B, the data historian application(s) 173A and data historian database(s) 173B may be centralized and have a unitary logical appearance to the process control system 100 (although multiple instances of a data historian application 173A may execute simultaneously within the process control system 100), and the data historian database(s) 173B may be stored in a single physical data storage device or across multiple data storage devices.

In some configurations, the process control system 100 includes one or more other wireless access points 174 that communicate with other devices using other wireless protocols, such as IEEE 802.11-compliant wireless local area network protocols, mobile communication protocols such as WiMAX (Worldwide Interoperability for Microwave Access), LTE (Long Term Evolution) or other ITU-R (International Telecommunication Union Radiocommunication Sector) compatible protocols, short-wavelength radio communications such as near field communications (NFC) or Bluetooth, and/or other wireless communication protocols. Typically, such wireless access point(s) 174 allow handheld or other portable computing devices (e.g., user interface devices 175) to communicate over a respective wireless process control communication network that is different from the wireless network 170 and that supports a different wireless protocol than the wireless network 170. For example, a wireless or portable user interface device 175 may be a mobile workstation or diagnostic test equipment that is utilized by an operator within the process plant 100 (e.g., an instance of one of the operator workstations 171). In some scenarios, in addition to portable computing devices, one or more process control devices (e.g., controller 111, field devices 115-122, wireless devices 135, 140-158, etc.) also communicate using the wireless protocol supported by the wireless access point(s) 174.

It is noted that although FIG. 1 only illustrates a single process controller 111, and a particular number of field devices 115-122 and 140-146, wireless gateways 35, wireless adaptors 152, access points 155, routers 1158, and wireless process control communications networks 170 included in the example process plant 100, this is only an illustrative and non-limiting embodiment. For example, any number of controllers 111 may be included in the process control plant or system 100, and any of the controllers 111 may communicate with any number of wired or wireless devices and networks 115-122, 140-146, 135, 152, 155, 158 and 170 to control a process in the plant 100.

### Example Interlock Configuration Object

As explained above, system designers may use the configuration system 172 to create or configure process control modules and send these modules via the backbone 110 (or another network) to the process controller 111 and/or other process controllers. One or more of these process control modules may enable the receiving controller(s) to automatically shut down or de-energize field devices or other components as needed when certain other devices or components fail or experience problems. For example, a configuration engineer may program a pump that feeds a tank to automatically shut down if and when an outlet valve of the tank fails or otherwise stops operating properly. The triggering conditions, and the appropriate/desired responses, among the field devices/components collectively form “interlock logic” according to which the controller(s) manage interlock events.

As noted above, in some embodiments where object oriented programming is utilized, the configuration application(s) 172A provide, out-of-box to customers/designers, an interlock configuration object (e.g., within, or otherwise associated with, a control module). The system designer(s) may create instances of the interlock configuration object as needed to generate the interlock logic for the process control system 100. Each interlock configuration object may represent the individual interlocking or chaining between two field devices or other components. In the pump/tank/valve scenario described above, for instance, a single instance of an interlock configuration object may include parameters defining the interlock between the outlet valve and the input pump. For example, the object instance may include device identifiers of the specific pump and valve and, because the operational state of the outlet valve dictates whether the input pump must be shut off, the interlock configuration object may define the valve as the “parent” and the pump as the “child” in the interlock relationship.

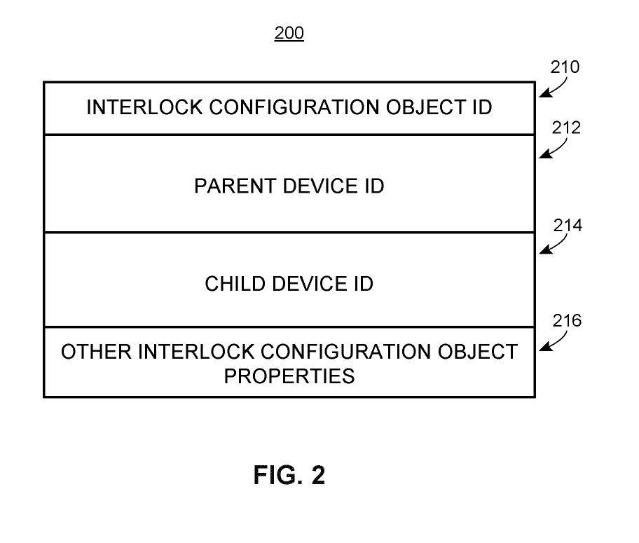

FIG. 2 depicts an example interlock configuration object 200 that may be used when configuring interlocks the process control system 100 of FIG. 1 (or other process control systems). As seen in FIG. 2, the interlock configuration object 200 is associated with properties that include an interlock configuration object identifier (ID) 210, a parent device ID 212, a child device ID 214, and other interlock configuration object properties 216.

The interlock configuration object ID 210 is a unique identifier for a given instance of the interlock configuration object 200, which may be specified by the user or automatically assigned. The parent device ID 212 is the unique identifier for the parent device of the interlock (e.g., an ID of a device object instance for the parent device), and the child device ID 214 is the unique identifier for the child device of the interlock (e.g., an ID of a device object instance for the child device). In operation (i.e., during run-time), when a process controller (e.g., controller 111 of FIG. 1) learns of stoppage/failure of a parent device, the controller accesses any interlock objects associated with the parent device to automatically shut down or de-energize the child device(s).

It will be understood that parent and child devices need not be physically coupled in series, or even have any physical, operative relationship. For example, a system designer may desire (e.g., during a testing phase) to automatically shut down all field devices when a single device fails, rather than only shutting down devices that are physically upstream or downstream of the failing device, etc. In such a scenario, the designer may use multiple instances of the interlock configuration object 200 to link all field devices to each other in a bidirectional manner (i.e., so that each device is both a parent to, and a child of, every other device).

The other interlock configuration object properties 216 may include one or more other properties. For example, the properties 216 may include properties that specify the timing and/or order of automatic shutdown between the parent and child devices, properties that indicate whether any interlock chain including the interlock represented by the interlock configuration object 200 can be bypassed, and so on.

It will be understood that the interlock configuration object 200 may expose more, fewer, and/or different properties than those shown in FIG. 2 for configuration purposes. For example, the other properties 216 may be omitted from the object 200. As another example, while the interlock configuration object 200 shown in FIG. 2 only includes IDs of one parent device and one child device, in other embodiments and/or scenarios the object 200 may include IDs of multiple parent devices and/or multiple child devices. Further, in some embodiments, the object 200 may be flexible enough to include arbitrary numbers of parent and/or child device IDs. In other embodiments, different object instances (or different objects) must be used in scenarios where a single device or component has more than one parent, where a single device or component has more than one child, and/or where a bidirectional parent/child relationship is desired.

A system designer may configure instances of the interlock configuration object 200 by entering, configuring, or otherwise defining the desired values for the various properties 210-216 via a user interface, such as a user interface of the configuration system 172. In some embodiments, however, at least some of the desired property values 210-216 (e.g., the interlock configuration object ID 210) may be automatically configured or populated by the configuration application 172A.

### Example Interlock Chain Diagrams

Various embodiments and scenarios will now be described in order to illustrate the manner in which interlock chain diagrams may be automatically generated and presented to users/operators (e.g. via one or more of operator workstation(s) 171, and/or one or more of user interface device(s) 175, during run-time operation of the process control plant 100). Purely for ease of explanation, the example interlock chain scenarios described below consist of relatively simple arrangements of conveyors having interlocked conveyor motors. It will be understood, however, that the techniques and visualizations described herein may apply to any other suitable components (e.g., valves, pumps, sensors, etc., portions of such devices, systems or sub-systems that include multiple devices or pieces of equipment, and so on), in any physical and/or logical combination or arrangement.

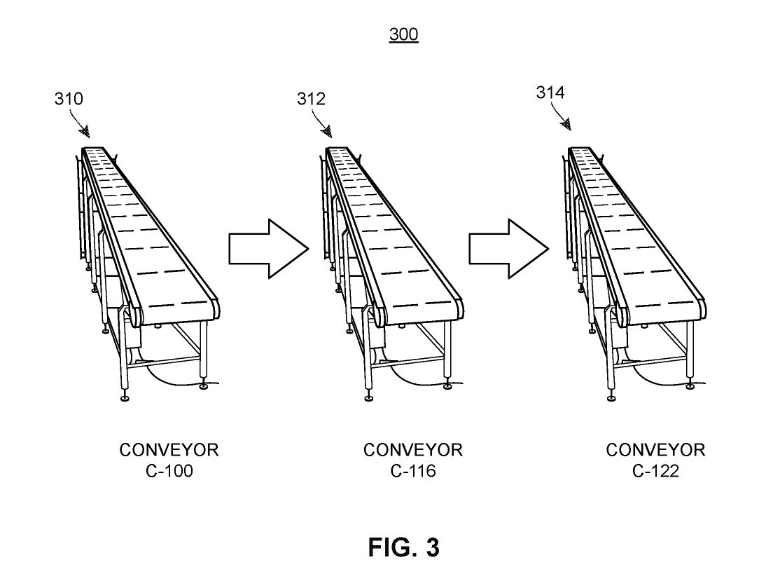

Referring first to FIG. 3, an example physical configuration 300 of conveyors 310-314 may exist in the process control system 100 of FIG. 1. The motors of the conveyors 310-314 may be included among the field devices 115-122 of FIG. 1, and/or among the field devices 140-150 of FIG. 1, for example. In the physical configuration 300, the conveyors 310-314 are in a simple series arrangement, with the conveyor 310 being upstream of the conveyor 312, and with the conveyor 312 being upstream of the conveyor 314. Thus, the conveyor 310 transports/delivers materials to the conveyor 312, and the conveyor 312 transports/delivers materials to the conveyor 314. The labels “C-100,” “C-116,” and “C-122” are IDs of the respective motors of the conveyors 310-314.

During the configuration stage, in order to prevent situations where materials are delivered to an inoperative conveyor and thereby cause blockage, back-up, and/or overflow, a system designer may desire to create a set of interlocks specifying that a motor of the conveyor 310 is a child of the motor of the conveyor 312, and that a motor of the conveyor 312 is a child of a motor of the conveyor 314. If device objects and an interlock configuration object are available to the designer, for example, the designer may utilize device object instances for the conveyor motors to create instances of the interlock configuration object. For example, a first instance of the interlock configuration object 200 of FIG. 2 may designate the motor of conveyor 310 as the child of the motor of conveyor 312, and a second instance of the interlock configuration object 200 may designate the motor of conveyor 312 as the child of the motor of conveyor 314. In particular, the IDs/designators of the conveyor motors (i.e., “C-100,” “C-116,” or “C-122”) may be used as the parent device ID 212 or the child device ID 214 of the object 200, as needed to set up the desired interlock relationships. In other embodiments, the designer may use other, non-object oriented programming to configure the interlock logic.

During run-time, an operator (e.g., a user of one of the operator workstation(s) 171 or one of the user interface device(s) 175) may selectively view various kinds of displays in order to monitor operations, and/or to take diagnostic, corrective, maintenance, and/or other actions, as discussed above in connection with FIG. 1. For example, the operator may view control displays that include indicators/readings of various parameters (e.g., temperatures, pressures, fill levels, etc.) measured by field devices, and/or showing the operative state of various field devices (e.g., operational, stopped, out-of-tolerance alert, etc.).

In some embodiments, the motors for each of the conveyors 310-314 is associated with a display view. For example, during run-time, an operator may select a display view for the “C-122” motor, and in response a display application (e.g., executing on an operator workstation 171 or user interface device 175 of the operator) may present information about the current state of the C-122 motor. The display view may indicate whether the C-122 motor is currently energized/operational, whether there are currently any fault or error messages for the C-122 motor, and so on. The display view may also indicate which devices, if any, are upstream and downstream of the C-122 motor (i.e., in the scenario of FIG. 3, indicate that the device ID “C-116” is upstream of the C-122 motor).

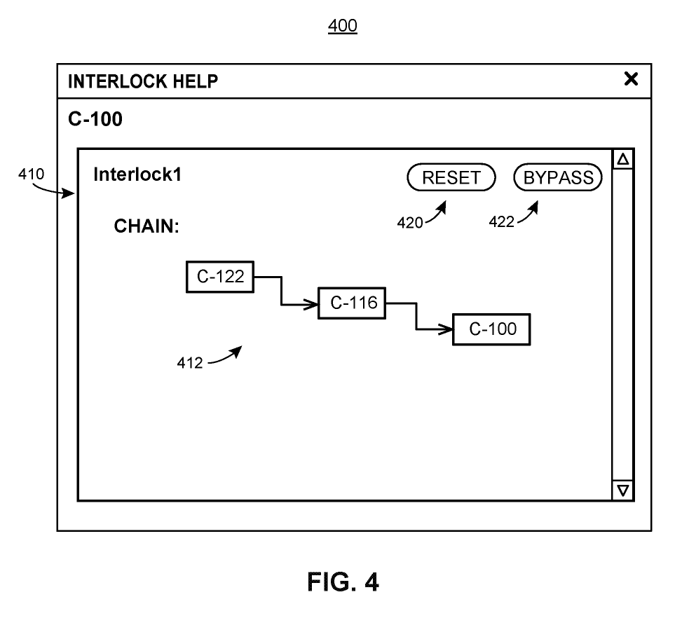

If an interlock is triggered during run-time, interlock chain information may be displayed to the operator. The information may be displayed automatically (e.g., within a device display currently being viewed, if that device was stopped by the interlock event), or may require some action(s) by the operator (e.g., clicking on or otherwise selecting an “Interlock Help” button or other virtual control on the device display view, etc.). FIG. 4 depicts an example of interlock information 400 that may be presented to the operator after an interlock has been triggered for the interlock chain that includes the motors of the conveyors 310-314. The window containing the interlock information 400 may be launched from the device display view for the C-100 motor associated with the conveyor 310. In other embodiments, the interlock information 400 may be presented in a different manner (e.g., within a same window that contains the device display view, etc.).

The interlock information 400 includes an interlock chain diagram 410 with a single interlock chain visualization 412 corresponding to an interlock chain that was configured by a system designer for the motors of the conveyors 310-314. In the example interlock chain visualization 412, each of the conveyor motors is represented by a different graphical element, and the graphical elements are arranged in accordance with the configured parent/child relationships (e.g., as specified in the respective instances of the interlock configuration object 200).

To ensure that the interlock chain visualization 412 represents the current state of the interlock logic, the display application may generate the interlock chain visualization 412 by analyzing/interpreting the current interlock logic. If object oriented programming was used to configure the process control system 100, for example, the display application may analyze instances of the interlock configuration object 200 to generate the interlock chain visualization 412. In one embodiment, for instance, the display application identifies all instances of the interlock configuration object 200 that reference (e.g., in either of field/property 212 or field property 214) the device corresponding to a currently-selected device display view. The display application may also determine which other devices are referenced in those object instances, and repeat the process for each such device (i.e., identify all instances of the interlock configuration object 200 that reference such devices, etc.), until no new devices are found. Having identified all relevant object instances (or while still doing so), the display application may use the specified parent/child relationships to build the interlock chain visualization 412.

Thus, unlike displays of conventional process control systems, an interlock chain may be visualized in its current form, without necessarily requiring any manual configuration of the device display view or any other display view. Moreover, the example interlock chain diagram 410 includes a virtual reset control 420, which the operator may activate to reset all devices within the interlock chain represented by interlock chain visualization 412. This may save the operator a significant amount of time by avoiding the need to (1) navigate through the display views of the different, chained devices and (2) activate reset controls in each such display view on a one-by-one basis. Moreover, human error in the reset process (e.g., forgetting to reset one device in the chain, etc.) may be avoided in this manner. In the embodiment of FIG. 4, the interlock chain diagram 410 also includes a virtual bypass control 422, which the operator may activate to bypass the interlock for the visualized chain. While FIG. 4 depicts the reset control 420 and bypass control 422 as virtual buttons, other embodiments may use virtual toggle switches, selectable menu items, etc. Moreover, in some embodiments, the operator may be required to indicate confirmation after selecting the reset control 420 or the bypass control 422 (e.g., by selecting a virtual “Confirm” button).

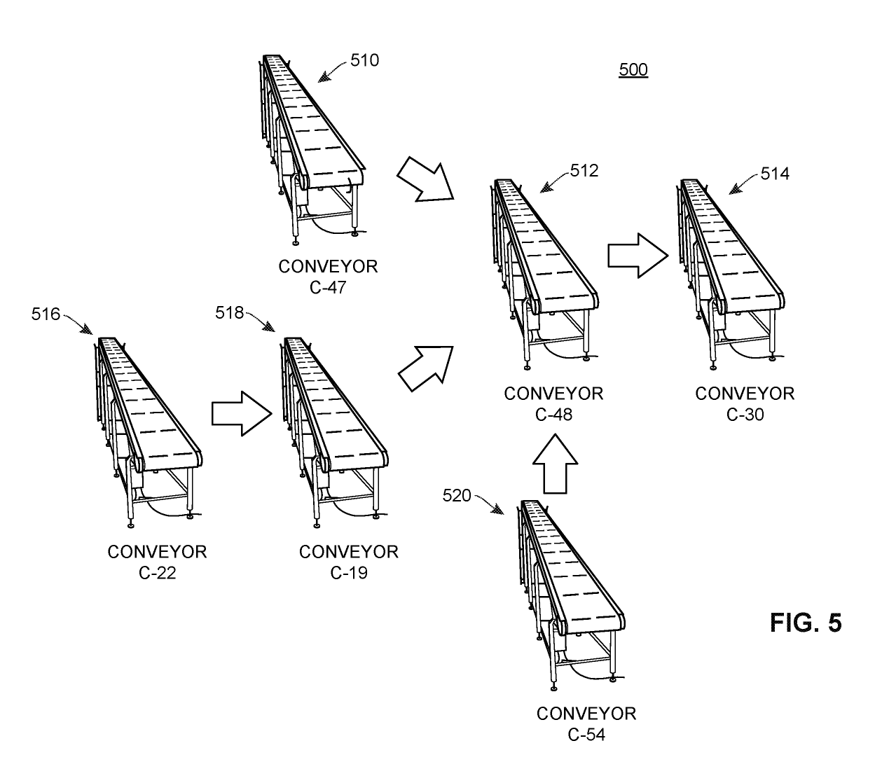

A somewhat more complex, example physical configuration 500 of conveyors 510-520 is shown in FIG. 5. The motors of the conveyors 510-520 may be included among the field devices 115-122 of FIG. 1, and/or among the field devices 140-150 of FIG. 1, for example. The labels “C-47,” “C-48,” “C-30,” etc., are IDs of the respective motors of the conveyors 510-520. The motors of the conveyors 510-520 may be associated with device objects, and the interlock relationships may be associated with interlock objects, in a manner similar to that discussed above in connection with FIG. 3. Also as discussed above, if an interlock is triggered during run-time, interlock chain information may be displayed to the operator, either automatically or in response to one or more actions by the operator.

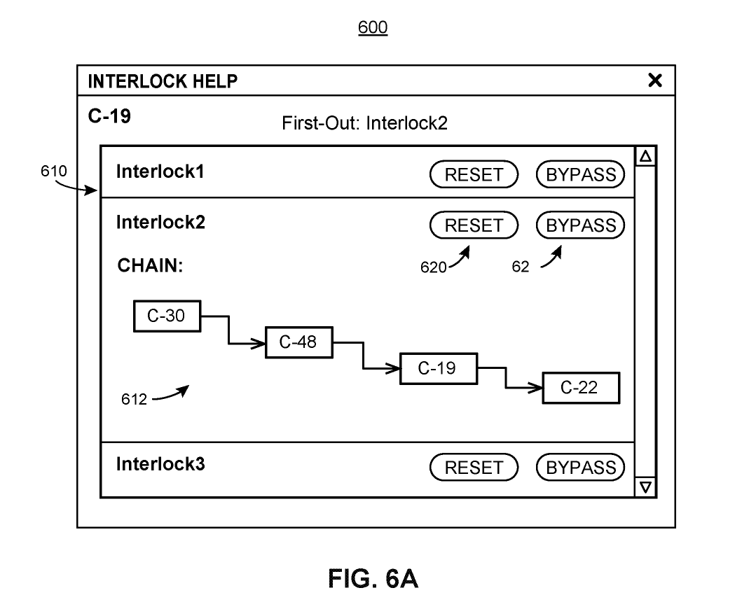

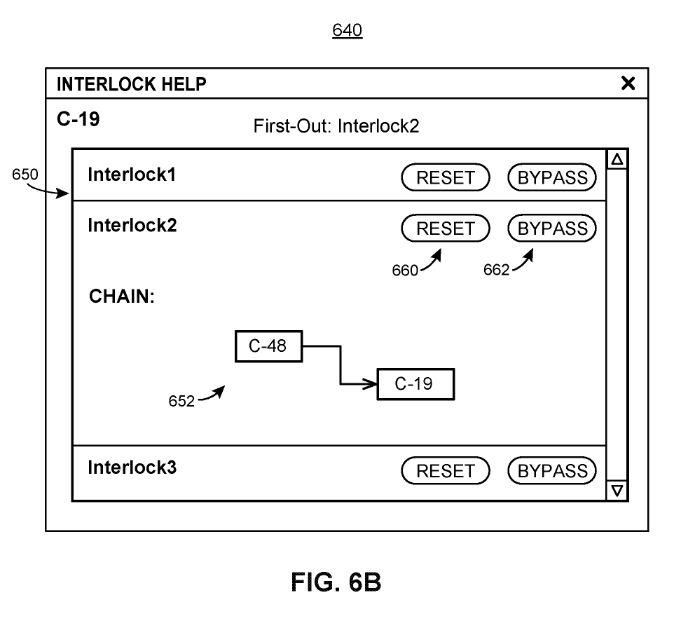

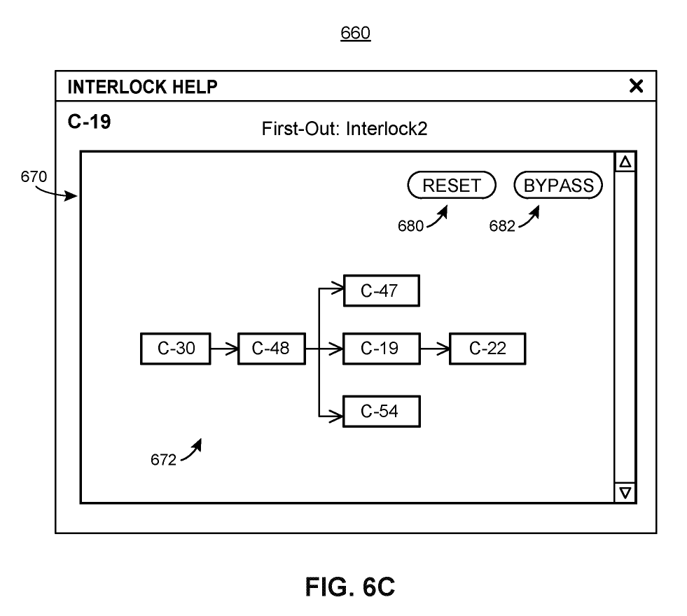

FIG. 6A depicts an example of interlock information 600 that may be presented to the operator after an interlock has been triggered for the interlock chains that include the motors of the conveyors 510-520, and that is launched from the device display view for the C-19 motor associated with the conveyor 518. The interlock information 600 includes an interlock chain diagram 610 with three sections, each associated with a visualization for a different (but related) interlock chain that has been triggered. The interlock information 600 also includes an indicator of which interlock chain(s) include(s) the component that triggered the interlock (i.e., in this example scenario, Interlock2, as indicated by the text “First-Out: Interlock2”). Alternatively, the interlock chain diagram 610 may only enable the operator to view a visualization for the chain that includes the device or component from whose display the interlock information 600 was launched (here, the visualization 612 labeled “Interlock2” that includes a graphic representation of the C-19 motor). In the example embodiment of FIG. 6A, the operator may view only one of the three interlock chain visualization at a time (e.g., in the depicted scenario, the interlock chain visualization 612). All other visualizations may be collapsed or hidden until the operator selects another one (e.g., by clicking on the section of the interlock chain diagram 610 that is associated with that chain). In some embodiments, one or more rules may govern which visualization appears first (e.g., a visualization for the chain that includes the field device from whose display view the interlock information 600 was launched, and/or a visualization for the chain that includes the primary source/cause of the interlock, etc.). In the embodiment of FIG. 6A, for example, the interlock chain diagram 610 may appear initially due to the inclusion of the C-19 motor in that chain. The operator may then select any other chain visualization, causing that visualization to appear and the visualization 612 to be hidden or collapsed.

The display application that generates the interlock chain diagram 610 may determine how many chain visualizations to create/present based on the relationship between the interlock chain of a selected, interlocked device and other interlock chains that share a common parent or “root” component. In the physical configuration 500, for example, three interlock chains share the parent C-48 motor (and therefore have the same root device, i.e., the C-30 motor): a first chain including the C-47, C-48, and C-30 motors, a second chain including the C-22, C-19, C-48, and C-30 motors, and a third chain including the C-54, C-48, and C-30 motors. Accordingly, the interlock chain diagram 610 includes three expandable/collapsible sections for visualizing three different but related interlock chains.

As seen in FIG. 6A, the interlock chain diagram 610 also includes, in the section for the interlock chain visualization 612, a virtual reset control 620 and bypass control 622, which may be similar to the controls 420 and 422, respectively, of FIG. 4. In the depicted embodiment, similar controls are included for each of the other two chains. While FIG. 6A shows an embodiment in which the operator can reset or bypass devices in a chain without expanding the respective visualization, other embodiments may hide such controls until the respective chain visualization is made visible.

In the example interlock chain diagram 610, each interlock chain visualization, when displayed, is shown in its entirety (i.e., from the first parent or “root” component through the last child component). In other embodiments, however, the number of components shown within a given chain visualization depends on (1) the location of the component that caused the interlock (e.g., by malfunctioning), and/or (2) the location of the component within the chain from whose display view the interlock information 600 was launched. In one such embodiment, the interlock chain visualization shows only the portion of the chain between (and including) the presently-selected component and the cause/source of the interlock/stoppage (i.e., the device or other component that is ultimately responsible for the automatic stoppage of the user-selected component).

As an example of such an embodiment, FIG. 6B depicts interlock information 640 in a scenario where the C-48 motor has triggered an interlock, and where the user and/or display application has launched the view of the interlock information 640 from the device display view for the C-19 motor. As seen in FIG. 6B, within an interlock chain diagram 650, the interlock chain visualization 652 for “Interlock2” now only includes graphic representations of the C-48 and C-19 motors. If additional devices or components were instead included in the interlock chain between the C-48 and C-19 motors, the visualization 652 would further include graphic representations of those intermediary devices/components.

Moreover, in alternative embodiments, an interlock chain diagram may portray multiple interlock chains in a combined manner. As just one example of such an embodiment, FIG. 6C depicts interlock information 660 that includes an interlock chain diagram 670 that simultaneously shows all three interlock chains corresponding to the physical configuration 500 of FIG. 5. A virtual reset control 680 and bypass control 682 may be utilized by the operator to reset (or bypass the interlock for) all devices or components in the collection of related interlock chains (or separate controls may still be displayed for separate interlock chains, etc.).

While each graphical element is depicted in FIGS. 4 and 6A-6C as a rectangle that includes the device ID, other graphical elements or representations may be used (e.g., circles, bare IDs, conveyor motor icons, etc.). Moreover, while FIGS. 4 and 6A-6C depicts parents to the left and children to the right, with an arrow leading from parent to child, other embodiments may portray parent/child relations differently (e.g., cascading downwards, as nested boxes, etc.).

Further, in an alternative embodiment, interlock visualization chains such as those shown in FIGS. 4 and 6A-6C may be presented or launched independently of any field device display view. For example, a new window showing (or providing links to) visualizations for the interlock chains of all currently interlocked devices (or all currently bypassed interlock chains, etc.) may automatically appear when an interlock event occurs, or when an operator selects a particular menu item, tab, or other control from a control module display view, etc.

### Example Interlock Chain Visualization Method

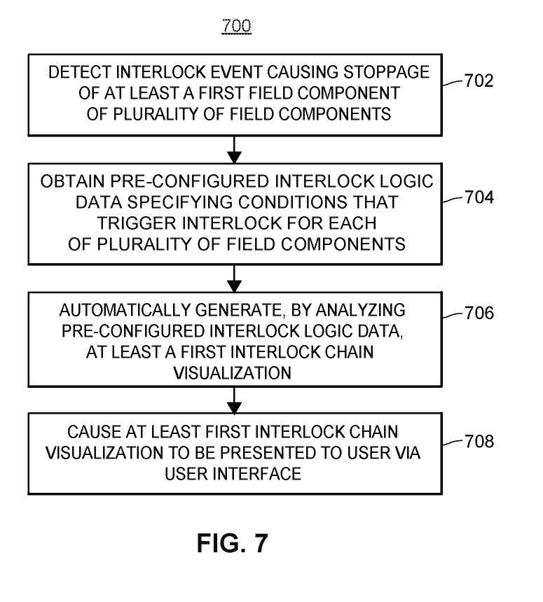

FIG. 7 depicts an example method 700 of visualizing one or more interlock chains in a process control system that includes a plurality of field components (e.g., conveyor motors, pumps, valves, sensors, and/or other devices, equipment, subsystems, etc.). The field components may consist of, be a subset of, or include the field devices 115-122 and/or 140-150 of FIG. 1, for example, and may or may not include all of the field components within the process control system. The field components implement respective functions (e.g., physical functions such as moving materials, opening or closing of a valve, pumping liquids, sensing physical characteristics or parameters, etc.) in accordance with one or more process control modules (e.g., process control routines 138 of FIG. 1). The method 700 may be performed in part or in its entirety by one or more of operator workstation(s) 171, one or more of user interface device(s) 175 of FIG. 1, and/or one or more other devices or systems within the process control system 100 of FIG. 1 that execute a display application stored in one or more memories, for example.

At block 702 of the method 700, an interlock event that caused (or is in the process of causing) a stoppage of at least a first field component of the field components is detected. The first field component may or may not be the source of the interlock event (i.e., may or may not be the component that triggered the interlock by failing to work properly). As one example, block 702 may be implemented by receiving, from the process controller 111 of FIG. 1 and via the backbone 110, data indicating that a particular interlock chain has been stopped or de-energized. The process controller 111 may have initiated the interlock/stoppage of the chain in response to receiving, from one of the plurality of field components (or a sensor that monitors operation of that component, etc.), an error or fault code (or other data indicative of a problem) indicating that the component has stopped working (or is no longer operating within fault tolerances, etc.).

At block 704, pre-configured interlock logic data associated with the plurality of field components is obtained. Block 704 may occur before and/or after block 702. The interlock logic data, which may have been manually configured by one or more system designers, specifies conditions that trigger interlock for each of the plurality of field components. In some embodiments where the system designer(s) used object oriented programming to configure some or all of the process control system, the interlock logic data includes data defining interlock configuration objects that conform to a particular object oriented programming protocol. In such an embodiment, each of the interlock configuration objects (e.g., object instances) may represent an interlocking relationship between a respective pair of field components among the plurality of field components. For example, the interlock configuration object 200 of FIG. 2, or a similar object, may be used.

At block 706, at least a first interlock chain visualization is automatically generated by analyzing the interlock logic data obtained at block 704 Like block 704, block 706 may occur before and/or after block 702. Block 706 may include automatically generating the GUI data that is required to render a display that includes at least the first interlock chain visualization, such that the display can be presented to a user. The first interlock chain visualization graphically indicates interlock dependencies among at least a subset of the plurality of field components, including the first field component and at least one other field component of the plurality of field components. The field components may be represented by respective graphical elements, such as rectangles, circles, icons, etc. If the interlock logic data obtained at block 704 includes interlock configuration objects (e.g., object instances), block 706 may include automatically generating the first interlock chain visualization based at in least in part upon those interlock configuration objects (e.g., by analyzing the parent and child properties of each object, using the device identifiers of parent and/or child devices to identify other interlock configuration objects associated with those parent/child devices, etc., as discussed above).

At block 708, at least the first interlock chain visualization is caused to be presented to a user (e.g., a human operator) via a user interface of a computing device. For example, the display data generated at block 708 may be used by a computing device implementing the method 750 (e.g., one of operator workstation(s) 171 or user interface device(s) 175 of FIG. 1) to display the first interlock chain visualization to the user or, alternatively, the display data may be transmitted by such a computing device to another computing device or terminal that will display the first interlock chain visualization to the user.

In some embodiments, the method 700 includes additional blocks not shown in FIG. 7. For example, the method 700 may include an additional block in which a device display view for the first field component is presented to the user (e.g., prior to, or contemporaneously with, display of the first interlock chain visualization). Such a block may include causing information associated with the first field component (e.g., a state of the first field component and/or a measurement obtained by the first field component) to be presented to the user via the user interface. Moreover, in such an embodiment, the first interlock chain visualization generated at block 706 may extend only between a graphic representation of the first field component and a graphic representation of the field component that triggered the interlock event. Alternatively, the first interlock chain visualization may extend at least between a graphic representation of a root field component of the first interlock chain and a graphic representation of the first field component, up to (potentially) the entirety of the interlock chain that includes both of those components.

The method 700 may also include a block (also not shown in FIG. 7), similar to block 706, in which a second, different interlock chain visualization is automatically generated, where the second chain visualization is related to the first. For example, the first interlock chain visualization may extend at least between a graphic representation of a field component shared between the first interlock chain and the second interlock chain, and the graphic representation of the first field component, and the second interlock chain visualization may extend at least between the graphic representation of the shared field component (or another graphic representation of that shared field component) and a graphic representation of the second field component. In such an embodiment, block 708 may further cause the second interlock chain visualization to be presented to the user via the user interface (e.g., contemporaneously with the first interlock chain visualization, or at a later time in response to the user selecting the second interlock chain visualization).

The method 700 may also, or instead, include a first additional block in which a single reset control is caused to be presented to the user via the user interface (e.g., contemporaneously with the first interlock chain visualization), a second additional block in which a user activation of the reset control is detected, and a third additional block in which, in response to detecting the user activation of the reset control, a reset of at least the first subset of the plurality of field components (e.g., a reset of all the field components represented in the first interlock chain visualization, and possibly also any components that are included in the interlock chain but not shown) is caused. For example, a computing device implementing the method 700 may send process controller 111 of FIG. 1 a request or command to reset the appropriate field components.

Still further, the method 700 may also, or instead, include additional blocks relating to a subsequent visualization after the interlock logic has been reconfigured (e.g., by a system designer). For example, in a first additional block (similar to block 702) that occurs subsequent to the blocks seen in FIG. 7, a subsequent interlock event that caused (or is in the process of causing) a stoppage of at least a second field component of the plurality of field components may be detected. In a second additional block (similar to block 704), updated interlock logic data that is associated with the plurality of field components may be obtained, where the updated interlock logic data specifies new conditions that trigger interlock for each of at least some of the plurality of field components. In a third additional block (similar to block 706) at least a second interlock chain visualization is automatically generated by analyzing the updated interlock logic data. Similar to the first interlock chain visualization, the second interlock chain visualization may graphically indicate interlock dependencies among at least a second subset of the plurality of field components. The second subset may include the second field component and at least one other field component of the plurality of field components. In a fourth additional block (similar to block 708), at least the second interlock chain visualization is caused to be presented to the user (or another user) via the user interface.

### Aspects of the Invention

Embodiments of the techniques described in the present disclosure may include any number of the following aspects, either alone or combination:

Aspect 1. A method of visualizing one or more interlock chains in a process control system, wherein a plurality of field components in the process control system implement a plurality of respective functions in accordance with one or more process control modules, and wherein the method comprises: (1) detecting, by one or more computing devices, an interlock event causing a stoppage of at least a first field component of the plurality of field components; (2) obtaining, by the one or more computing devices, pre-configured interlock logic data associated with the plurality of field components, wherein the pre-configured interlock logic data specifies conditions that trigger interlock for each of the plurality of field components; (3) automatically generating, by the one or more computing devices analyzing the pre-configured interlock logic data, at least a first interlock chain visualization, wherein the first interlock chain visualization graphically indicates interlock dependencies among at least a first subset of the plurality of field components, and wherein the first subset includes (i) the first field component and (ii) at least one other field component of the plurality of field components; and (4) causing, by the one or more computing devices, at least the first interlock chain visualization to be presented to a user via a user interface.

Aspect 2. The method of aspect 1, wherein: (1) the pre-configured interlock logic data includes data defining a plurality of interlock configuration objects conforming to an object oriented programming protocol; (2) each of the plurality of interlock configuration objects represents an interlocking relationship between a respective pair of field components among the plurality of field components; and (3) automatically generating at least the first interlock chain visualization includes automatically generating the first interlock chain visualization based at in least in part upon the plurality of interlock configuration objects.

Aspect 3. The method of aspect 1 or aspect 2, further comprising causing, by the one or more computing devices, information associated with the first field component to be presented to the user via the user interface, wherein the information associated with the first field component includes one or both of (i) a state of the first field component, and (ii) a measurement obtained by the first field component.

Aspect 4. The method of any one of aspects 1 through 3, wherein automatically generating at least a first interlock chain visualization includes automatically generating a first interlock chain visualization that extends only between a graphic representation of the first field component and a graphic representation of another field component that triggered the interlock event.

Aspect 5. The method of any one of aspects 1 through 3, wherein automatically generating at least a first interlock chain visualization includes automatically generating a first interlock chain visualization that extends at least between a graphic representation of a root field component of the first interlock chain and a graphic representation of the first field component.

Aspect 6. The method of any one of aspects 1 through 3, comprising: (1) automatically generating, by the one or more computing devices, a first interlock chain visualization that extends at least between (i) a graphic representation of a field component shared between the first interlock chain and a second interlock chain, and (ii) the graphic representation of the first field component; (2) automatically generating, by the one or more computing devices, a second interlock chain visualization that extends at least between (i) either the graphic representation of the shared field component or another graphic representation of the shared field component, and (ii) a graphic representation of a second field component of the plurality of field components; and (3) causing, by the one or more computing devices, at least the first interlock chain visualization and the second interlock chain visualization to be presented to the user via the user interface, wherein the graphic representation of the second field component is not included in the first interlock chain visualization, and the graphic representation of the first field component is not included in the second interlock chain visualization.

Aspect 7. The method of aspect 6, wherein causing at least the first interlock chain visualization and the second interlock chain visualization to be presented to the user via the user interface includes: (1) causing the first interlock chain visualization to be presented to the user via the user interface; and (2) causing the second interlock chain visualization to be presented to the user via the user interface, and the first interlock chain visualization to be hidden on the user interface, in response to the user selecting the second interlock chain visualization.

Aspect 8. The method of any one of aspects 1 through 7, further comprising: (1) causing, by the one or more computing devices, a single reset control to be presented to the user, via the user interface, contemporaneously with the first interlock chain visualization; (2) detecting, by the one or more computing devices, a user activation of the single reset control; and (3) in response to detecting the user activation of the single reset control, causing, by the one or more computing devices, a reset of at least the first subset of the plurality of field components.

Aspect 9. The method of any one of aspects 1 through 8, further comprising: (1) detecting, by the one or more computing devices, a subsequent interlock event causing a stoppage of at least a second field component of the plurality of field components; (2) obtaining, by the one or more computing devices, updated interlock logic data associated with the plurality of field components, wherein the updated interlock logic data specifies new conditions that trigger interlock for each of at least some of the plurality of field components; (3) automatically generating, by the one or more computing devices analyzing the updated interlock logic data, at least a second interlock chain visualization, wherein the second interlock chain visualization graphically indicates interlock dependencies among at least a second subset of the plurality of field components, and wherein the second subset includes (i) the second field component and (ii) at least one other field component of the plurality of field components; and (4) causing, by the one or more computing devices, at least the second interlock chain visualization to be presented via the user interface.

Aspect 10. A system for visualizing one or more interlock chains in a process control system, wherein a plurality of field components in the process control system implement a plurality of respective functions in accordance with one or more process control modules, and wherein the system comprises a configuration database, one or more computing devices, and one or more memories storing instructions that, when executed by one or more processors of the one or more computing devices, cause the one or more computing devices to: (1) detect an interlock event causing a stoppage of at least a first field component of the plurality of field components; (2) obtain, from the configuration database, pre-configured interlock logic data associated with the plurality of field components, wherein the pre-configured interlock logic data specifies conditions that trigger interlock for each of the plurality of field components; (3) automatically generate, by analyzing the pre-configured interlock logic data, at least a first interlock chain visualization, wherein the first interlock chain visualization graphically indicates interlock dependencies among at least a first subset of the plurality of field components, and wherein the first subset includes (i) the first field component and (ii) at least one other field component of the plurality of field components; and (4) cause at least the first interlock chain visualization to be presented to a user via a user interface.

Aspect 11. The system of aspect 10, wherein: (1) the pre-configured interlock logic data includes data defining a plurality of interlock configuration objects conforming to an object oriented programming protocol; (2) each of the plurality of interlock configuration objects represents an interlocking relationship between a respective pair of field components among the plurality of field components; and (3) the instructions cause the one or more computing devices to automatically generate at least the first interlock chain visualization based at in least in part upon the plurality of interlock configuration objects.

Aspect 12. The system of aspect 10 or aspect 11, wherein the instructions further cause the one or more computing devices to cause information associated with the first field component to be presented to the user via the user interface, wherein the information associated with the first field component includes one or both of (i) a state of the first field component, and (ii) a measurement obtained by the first field component.

Aspect 13. The system of any one of aspects 10 through 12, wherein the first interlock chain visualization extends only between a graphic representation of the first field component and a graphic representation of another field component that triggered the interlock event.

Aspect 14. The system of any one of aspects 10 through 12 wherein the first interlock chain visualization extends at least between a graphic representation of a root field component of the first interlock chain and a graphic representation of the first field component.

Aspect 15. The system of any one of aspects 10 through 12, wherein the instructions cause the one or more computing devices to: (1) automatically generate a first interlock chain visualization that extends at least between (i) a graphic representation of a field component shared between the first interlock chain and a second interlock chain, and (ii) the graphic representation of the first field component; (2) automatically generate a second interlock chain visualization that extends at least between (i) either the graphic representation of the shared field component or another graphic representation of the shared field component, and (ii) a graphic representation of a second field component of the plurality of field components; and (3) cause at least the first interlock chain visualization and the second interlock chain visualization to be presented to the user via the user interface, wherein the graphic representation of the second field component is not included in the first interlock chain visualization, and the graphic representation of the first field component is not included in the second interlock chain visualization.

Aspect 16. The system of any one of aspects 10 through 15, wherein the instructions further cause the one or more computing devices to: (1) cause a single reset control to be presented to the user, via the user interface, contemporaneously with the first interlock chain visualization; (2) detect a user activation of the single reset control; and (3) in response to detecting the user activation of the single reset control, cause a reset of at least the first subset of the plurality of field components.

Aspect 17. A non-transitory, computer-readable medium storing instructions that, when executed by one or more computing devices, cause the one or more computing devices to: (1) detect an interlock event causing a stoppage of at least a first field component of a plurality of field components in a process control system, wherein the plurality of field components implement a plurality of respective physical functions in accordance with one or more process control modules; (2) obtain pre-configured interlock logic data associated with the plurality of field components, wherein the pre-configured interlock logic data conditions that trigger interlock for each of the plurality of field components; (3) automatically generate, by analyzing the pre-configured interlock logic data, at least a first interlock chain visualization, wherein the first interlock chain visualization graphically indicates interlock dependencies among at least a first subset of the plurality of field components, and wherein the first subset includes (i) the first field component and (ii) at least one other field component of the plurality of field components; and (4) cause at least the first interlock chain visualization to be presented to a user via a user interface.

Aspect 18. The non-transitory, computer-readable medium of aspect 17, wherein: (1) the pre-configured interlock logic data includes data defining a plurality of interlock configuration objects conforming to an object oriented programming protocol; (2) each of the plurality of interlock configuration objects represents an interlocking relationship between a respective pair of field components among the plurality of field components; and (3) the instructions cause the one or more computing devices to automatically generate at least the first interlock chain visualization based at in least in part upon the plurality of interlock configuration objects.

Aspect 19. The non-transitory, computer-readable medium of aspect 17 or aspect 18, wherein the first interlock chain visualization extends only between a graphic representation of the first field component and a graphic representation of another field component that triggered the interlock event.

Aspect 20. The non-transitory, computer-readable medium of any one of aspects 17 through 19, wherein the instructions further cause the one or more computing devices to: (1) cause a single reset control to be presented to the user, via the user interface, contemporaneously with the first interlock chain visualization; (2) detect a user activation of the single reset control; and (3) in response to detecting the user activation of the single reset control, cause a reset of at least the first subset of the plurality of field components.

When implemented in software, any of the applications and functions described herein may be stored as instructions in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed:

1. A method of visualizing one or more interlock chains in a process control system, wherein a plurality of field components in the process control system implement a plurality of respective functions in accordance with one or more process control modules, and wherein the method comprises:
detecting, by one or more computing devices, an interlock event causing a stoppage of at least a first field component of the plurality of field components;
obtaining, by the one or more computing devices, pre-configured interlock logic data associated with the plurality of field components, wherein the pre-configured interlock logic data specifies conditions that trigger interlock for each of the plurality of field components;
automatically generating, by the one or more computing devices analyzing the pre-configured interlock logic data, at least a first interlock chain visualization, wherein the first interlock chain visualization graphically indicates interlock dependencies among at least a first subset of the plurality of field components, and wherein the first subset includes (i) the first field component and (ii) at least one other field component of the plurality of field components; and
causing, by the one or more computing devices, at least the first interlock chain visualization to be presented to a user via a user interface.

2. The method of claim 1, wherein:
the pre-configured interlock logic data includes data defining a plurality of interlock configuration objects conforming to an object oriented programming protocol;
each of the plurality of interlock configuration objects represents an interlocking relationship between a respective pair of field components among the plurality of field components; and
automatically generating at least the first interlock chain visualization includes automatically generating the first interlock chain visualization based at in least in part upon the plurality of interlock configuration objects.

3. The method of claim 1, further comprising:
causing, by the one or more computing devices, information associated with the first field component to be presented to the user via the user interface, wherein the information associated with the first field component includes one or both of (i) a state of the first field component, and (ii) a measurement obtained by the first field component.

4. The method of claim 3, wherein automatically generating at least a first interlock chain visualization includes:
automatically generating a first interlock chain visualization that extends only between a graphic representation of the first field component and a graphic representation of another field component that triggered the interlock event.

5. The method of claim 3, wherein automatically generating at least a first interlock chain visualization includes:
automatically generating a first interlock chain visualization that extends at least between a graphic representation of a root field component of the first interlock chain and a graphic representation of the first field component.

6. The method of claim 3, comprising:
automatically generating, by the one or more computing devices, a first interlock chain visualization that extends at least between (i) a graphic representation of a field component shared between the first interlock chain and a second interlock chain, and (ii) the graphic representation of the first field component;
automatically generating, by the one or more computing devices, a second interlock chain visualization that extends at least between (i) either the graphic representation of the shared field component or another graphic representation of the shared field component, and (ii) a graphic representation of a second field component of the plurality of field components; and
causing, by the one or more computing devices, at least the first interlock chain visualization and the second interlock chain visualization to be presented to the user via the user interface,
wherein the graphic representation of the second field component is not included in the first interlock chain visualization, and the graphic representation of the first field component is not included in the second interlock chain visualization.

7. The method of claim 6, wherein causing at least the first interlock chain visualization and the second interlock chain visualization to be presented to the user via the user interface includes:
causing the first interlock chain visualization to be presented to the user via the user interface; and
causing the second interlock chain visualization to be presented to the user via the user interface, and the first interlock chain visualization to be hidden on the user interface, in response to the user selecting the second interlock chain visualization.

8. The method of claim 1, further comprising:
causing, by the one or more computing devices, a single reset control to be presented to the user, via the user interface, contemporaneously with the first interlock chain visualization;
detecting, by the one or more computing devices, a user activation of the single reset control; and
in response to detecting the user activation of the single reset control, causing, by the one or more computing devices, a reset of at least the first subset of the plurality of field components.

9. The method of claim 1, further comprising:
detecting, by the one or more computing devices, a subsequent interlock event causing a stoppage of at least a second field component of the plurality of field components;
obtaining, by the one or more computing devices, updated interlock logic data associated with the plurality of field components, wherein the updated interlock logic data specifies new conditions that trigger interlock for each of at least some of the plurality of field components;
automatically generating, by the one or more computing devices analyzing the updated interlock logic data, at least a second interlock chain visualization, wherein the second interlock chain visualization graphically indicates interlock dependencies among at least a second subset of the plurality of field components, and wherein the second subset includes (i) the second field component and (ii) at least one other field component of the plurality of field components; and
causing, by the one or more computing devices, at least the second interlock chain visualization to be presented via the user interface.

10. A system for visualizing one or more interlock chains in a process control system, wherein a plurality of field components in the process control system implement a plurality of respective functions in accordance with one or more process control modules, and wherein the system comprises:
a configuration database;
one or more computing devices; and
one or more memories storing instructions that, when executed by one or more processors of the one or more computing devices, cause the one or more computing devices to
detect an interlock event causing a stoppage of at least a first field component of the plurality of field components,
obtain, from the configuration database, pre-configured interlock logic data associated with the plurality of field components, wherein the pre-configured interlock logic data specifies conditions that trigger interlock for each of the plurality of field components,
automatically generate, by analyzing the pre-configured interlock logic data, at least a first interlock chain visualization, wherein the first interlock chain visualization graphically indicates interlock dependencies among at least a first subset of the plurality of field components, and wherein the first subset includes (i) the first field component and (ii) at least one other field component of the plurality of field components, and
cause at least the first interlock chain visualization to be presented to a user via a user interface.

11. The system of claim 10, wherein:
the pre-configured interlock logic data includes data defining a plurality of interlock configuration objects conforming to an object oriented programming protocol;
each of the plurality of interlock configuration objects represents an interlocking relationship between a respective pair of field components among the plurality of field components; and
the instructions cause the one or more computing devices to automatically generate at least the first interlock chain visualization based at in least in part upon the plurality of interlock configuration objects.

12. The system of claim 10, wherein the instructions further cause the one or more computing devices to:
cause information associated with the first field component to be presented to the user via the user interface, wherein the information associated with the first field component includes one or both of (i) a state of the first field component, and (ii) a measurement obtained by the first field component.

13. The system of claim 12, wherein the first interlock chain visualization extends only between a graphic representation of the first field component and a graphic representation of another field component that triggered the interlock event.

14. The system of claim 12 wherein the first interlock chain visualization extends at least between a graphic representation of a root field component of the first interlock chain and a graphic representation of the first field component.

15. The system of claim 12, wherein the instructions cause the one or more computing devices to:
automatically generate a first interlock chain visualization that extends at least between (i) a graphic representation of a field component shared between the first interlock chain and a second interlock chain, and (ii) the graphic representation of the first field component;
automatically generate a second interlock chain visualization that extends at least between (i) either the graphic representation of the shared field component or another graphic representation of the shared field component, and (ii) a graphic representation of a second field component of the plurality of field components; and
cause at least the first interlock chain visualization and the second interlock chain visualization to be presented to the user via the user interface,
wherein the graphic representation of the second field component is not included in the first interlock chain visualization, and the graphic representation of the first field component is not included in the second interlock chain visualization.

16. The system of claim 10, wherein the instructions further cause the one or more computing devices to:
cause a single reset control to be presented to the user, via the user interface, contemporaneously with the first interlock chain visualization;
detect a user activation of the single reset control; and
in response to detecting the user activation of the single reset control, cause a reset of at least the first subset of the plurality of field components.

17. A non-transitory, computer-readable medium storing instructions that, when executed by one or more computing devices, cause the one or more computing devices to:
detect an interlock event causing a stoppage of at least a first field component of a plurality of field components in a process control system, wherein the plurality of field components implement a plurality of respective physical functions in accordance with one or more process control modules;
obtain pre-configured interlock logic data associated with the plurality of field components, wherein the pre-configured interlock logic data conditions that trigger interlock for each of the plurality of field components;
automatically generate, by analyzing the pre-configured interlock logic data, at least a first interlock chain visualization, wherein the first interlock chain visualization graphically indicates interlock dependencies among at least a first subset of the plurality of field components, and wherein the first subset includes (i) the first field component and (ii) at least one other field component of the plurality of field components; and
cause at least the first interlock chain visualization to be presented to a user via a user interface.

18. The non-transitory, computer-readable medium of claim 17, wherein:
the pre-configured interlock logic data includes data defining a plurality of interlock configuration objects conforming to an object oriented programming protocol;
each of the plurality of interlock configuration objects represents an interlocking relationship between a respective pair of field components among the plurality of field components; and
the instructions cause the one or more computing devices to automatically generate at least the first interlock chain visualization based at in least in part upon the plurality of interlock configuration objects.

19. The non-transitory, computer-readable medium of claim 17, wherein the first interlock chain visualization extends only between a graphic representation of the first field component and a graphic representation of another field component that triggered the interlock event.

20. The non-transitory, computer-readable medium of claim 17, wherein the instructions further cause the one or more computing devices to:
cause a single reset control to be presented to the user, via the user interface, contemporaneously with the first interlock chain visualization;
detect a user activation of the single reset control; and
in response to detecting the user activation of the single reset control, cause a reset of at least the first subset of the plurality of field components.
